(19) United States
(12) Patent Application Publication
(10) Pub. No.: US 2025/0102040 A1
(43) Pub. Date: Mar. 27, 2025

(54) SPRING ASSEMBLY INCLUDING TWO SEPARATE INDEPENDENT WAVE SPRINGS

(71) Applicant: Halliburton Energy Services, Inc., Houston, TX (US)

(72) Inventor: Peter D W Inglis, Angus (GB)

(21) Appl. No.: 18/829,715

(22) Filed: Sep. 10, 2024

Related U.S. Application Data
(60) Provisional application No. 63/585,858, filed on Sep. 27, 2023.

(51) Int. Cl. F16F 3/087; E21B 23/00; E21B 34/10; F16K 31/46

(52) U.S. Cl. CPC F16F 3/0876; E21B 23/004; E21B 34/102; F16K 31/46; E21B 2200/04

(57) ABSTRACT

Provided is a spring assembly, a valve assembly and a well system. The spring assembly, in one aspect, includes two separate independent wave springs positioned proximate one another such that peaks of adjacent ones of the two separate independent wave springs point toward one another, and valleys of the two separate independent wave springs point away from one another. The spring assembly, according to this aspect, further includes one or more anti-rotation features rotationally coupling the two separate independent wave springs together.

### CROSS-REFERENCE TO RELATED APPLICATION

This application claims the benefit of U.S. Provisional Application Ser. No. 63/585,858, filed on Sep. 27, 2023, entitled “SPRING ASSEMBLY INCLUDING TWO SEPARATE INDEPENDENT WAVE SPRINGS,” commonly assigned with this application and incorporated herein by reference in its entirety.

### BACKGROUND

Wellbores are sometimes drilled into subterranean formations to allow for the extraction of hydrocarbons and other materials. Valves are often disposed in a wellbore and are employed during one or more wellbore operations to restrict fluid flow through the wellbore.

### BRIEF DESCRIPTION

Reference is now made to the following descriptions taken in conjunction with the accompanying drawings, in which:

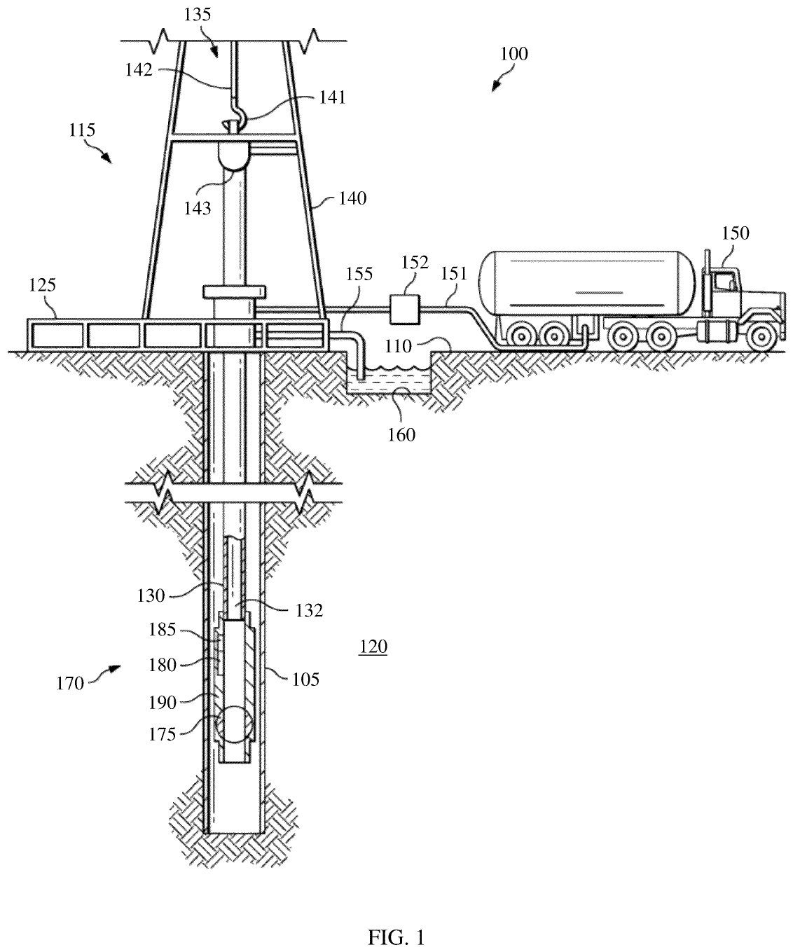

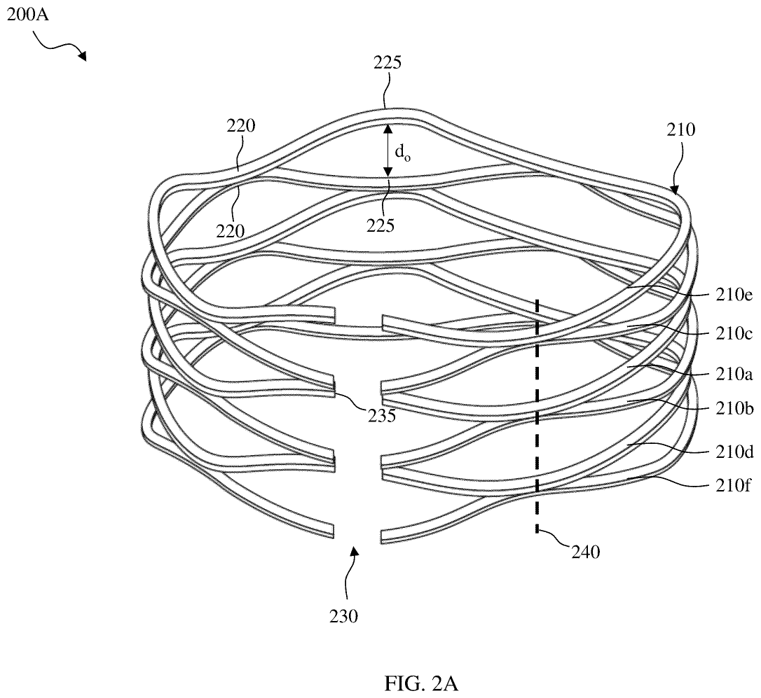

FIG. 1 illustrates a schematic, side view of a well system in which a valve assembly designed, manufactured and/or operated according to one or more embodiments of the disclosure is deployed in a wellbore;

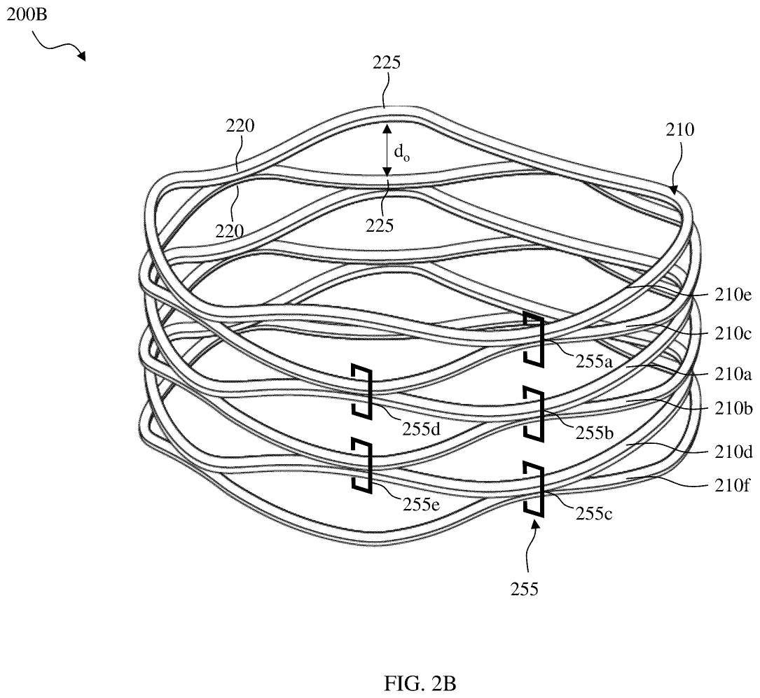

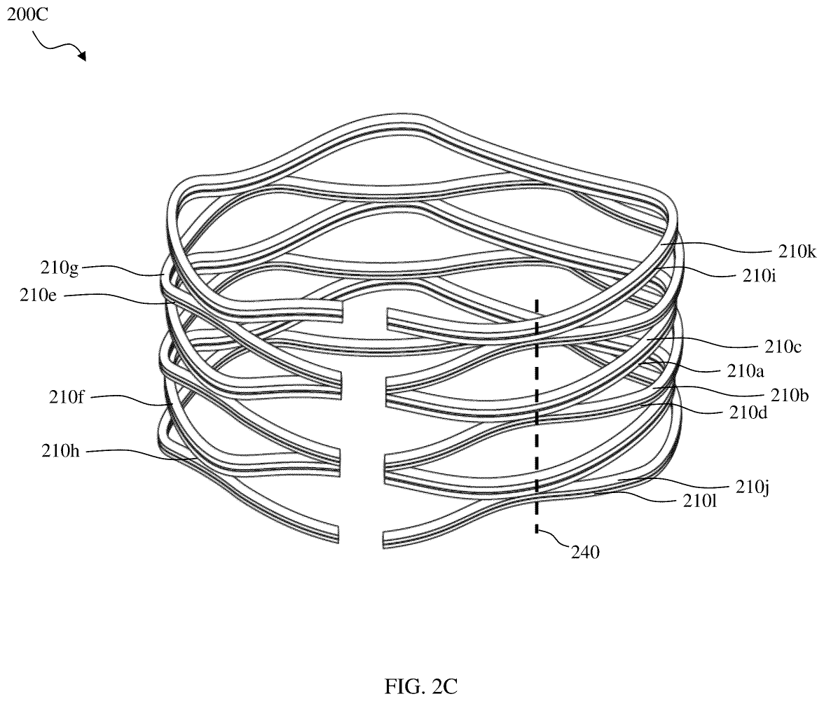

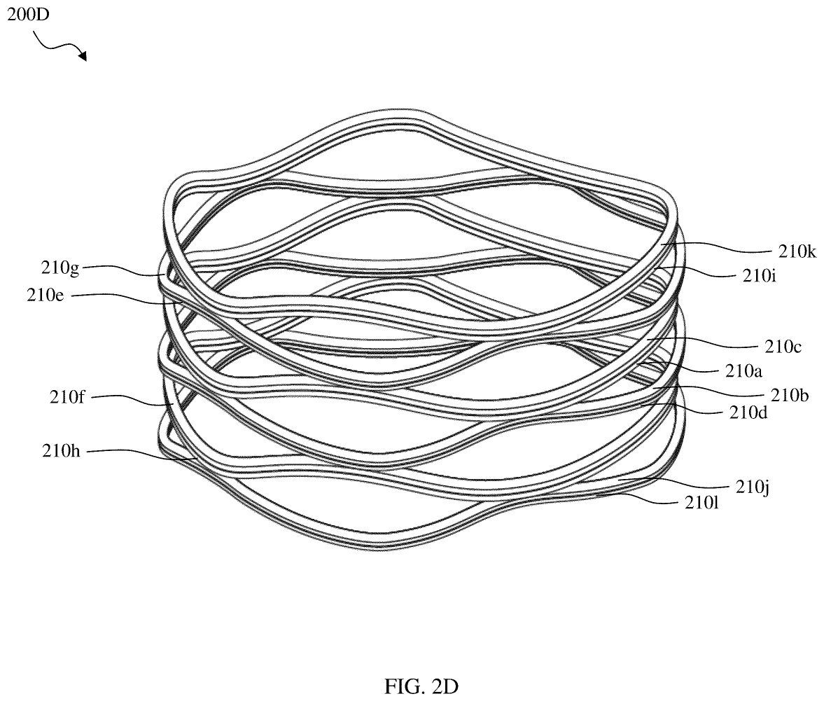

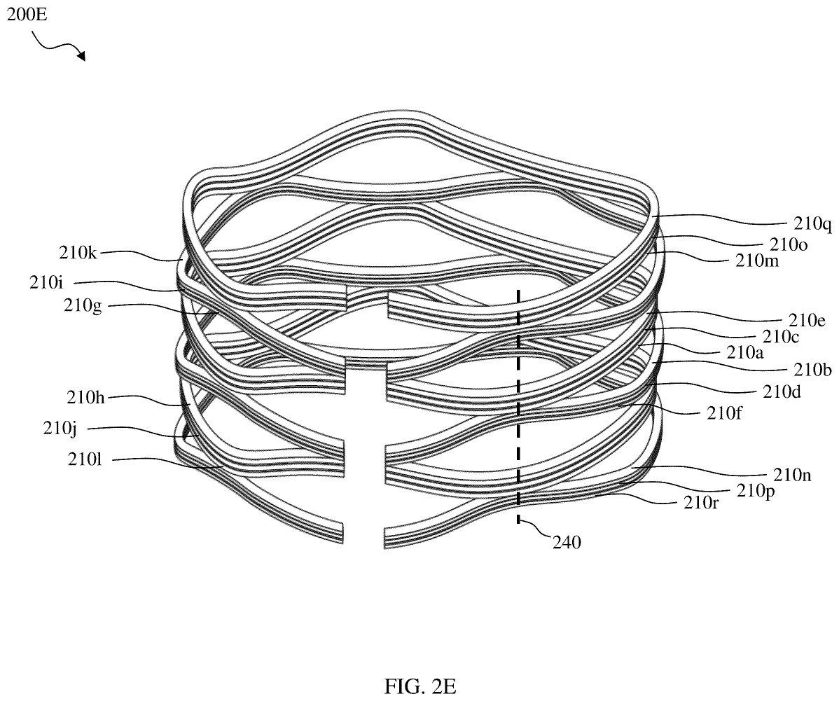

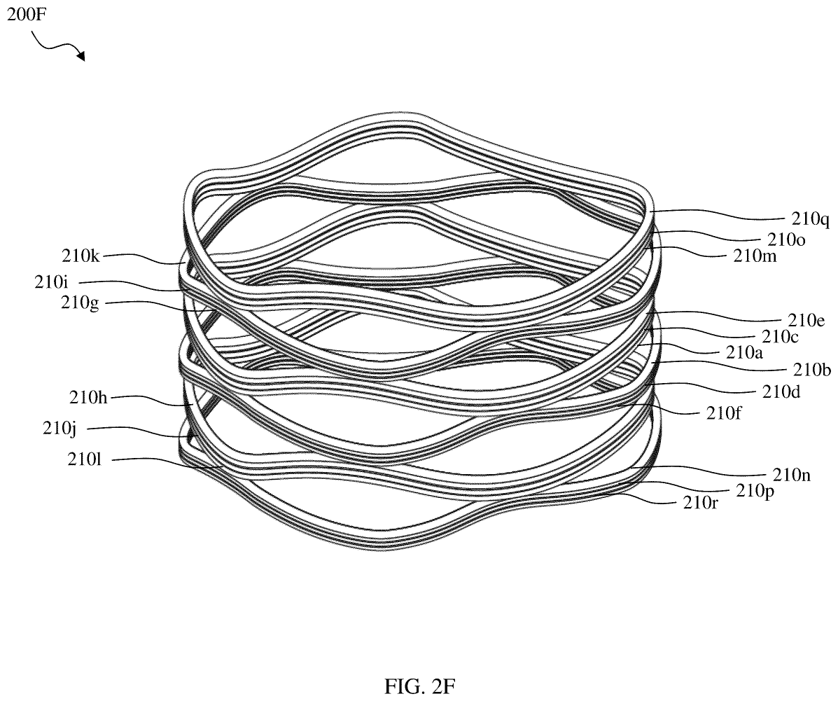

FIG. 2A illustrates a spring assembly designed, manufactured and/or operated according to one or more embodiments of the disclosure;

FIG. 2B illustrates a spring assembly designed, manufactured and/or operated according to one or more alternative embodiments of the disclosure;

FIG. 2C illustrates a spring assembly designed, manufactured and/or operated according to one or more alternative embodiments of the disclosure;

FIG. 2D illustrates a spring assembly designed, manufactured and/or operated according to one or more alternative embodiments of the disclosure;

FIG. 2E illustrates a spring assembly designed, manufactured and/or operated according to one or more alternative embodiments of the disclosure;

FIG. 2F illustrates a spring assembly designed, manufactured and/or operated according to one or more alternative embodiments of the disclosure; and

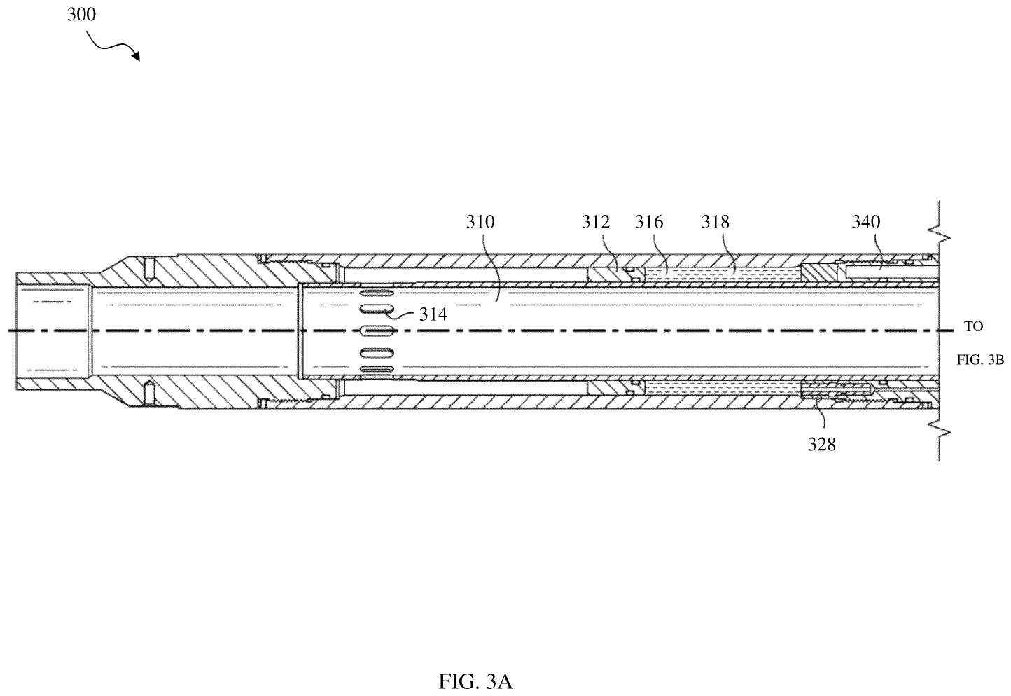

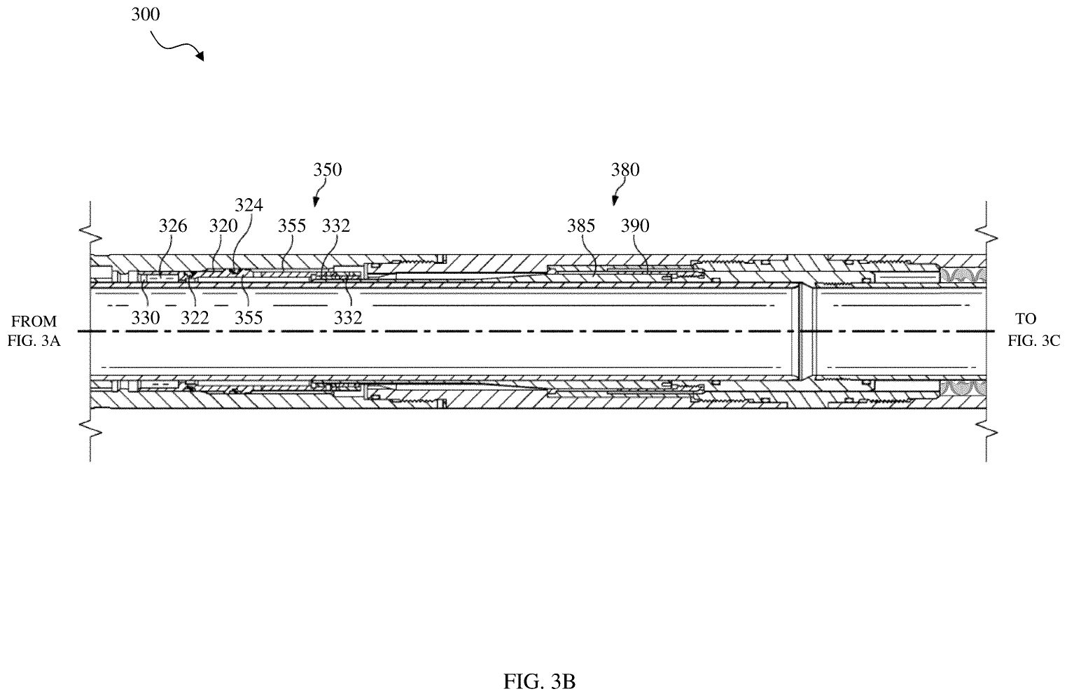

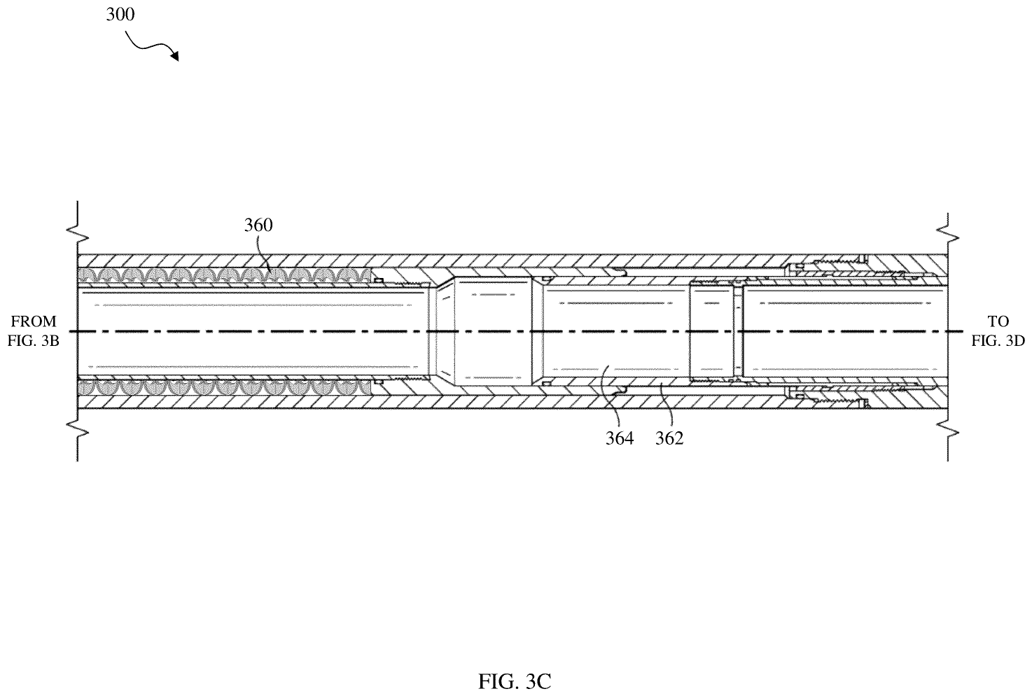

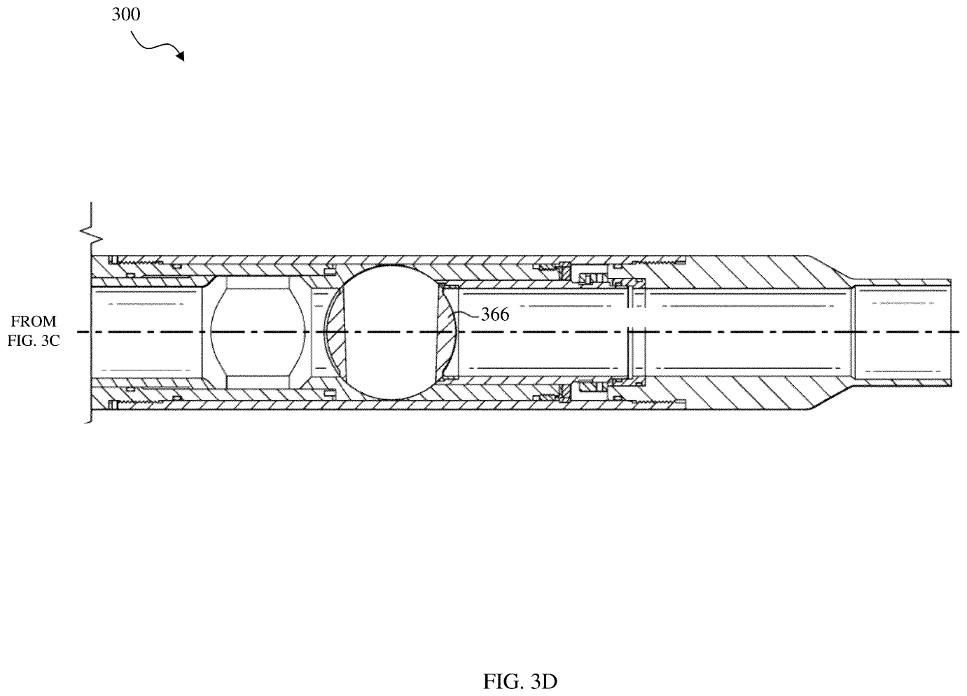

FIGS. 3A through 3D illustrate a schematic, cross-sectional view of a valve assembly including a spring assembly designed, manufactured and/or operated according to one or more embodiments of the disclosure.

### DETAILED DESCRIPTION

In the drawings and descriptions that follow, like parts are typically marked throughout the specification and drawings with the same reference numerals, respectively. The drawn figures are not necessarily to scale. Certain features of the disclosure may be shown exaggerated in scale or in somewhat schematic form and some details of certain elements may not be shown in the interest of clarity and conciseness. The present disclosure may be implemented in embodiments of different forms.

Specific embodiments are described in detail and are shown in the drawings, with the understanding that the present disclosure is to be considered an exemplification of the principles of the disclosure, and is not intended to limit the disclosure to that illustrated and described herein. It is to be fully recognized that the different teachings of the embodiments discussed herein may be employed separately or in any suitable combination to produce desired results.

Unless otherwise specified, use of the terms “connect,” “engage,” “couple,” “attach,” or any other like term describing an interaction between elements is not meant to limit the interaction to direct interaction between the elements and may also include indirect interaction between the elements described. Unless otherwise specified, use of the terms “up,” “upper,” “upward,” “uphole,” “upstream,” or other like terms shall be construed as generally away from the bottom, terminal end of a well, regardless of the wellbore orientation.; likewise, use of the terms “down,” “lower,” “downward,” “downhole,” “downstream,” or other like terms shall be construed as generally toward the bottom, terminal end of a well, regardless of the wellbore orientation. Use of any one or more of the foregoing terms shall not be construed as denoting positions along a perfectly vertical axis. In some instances, a part near the end of the well can be horizontal or even slightly directed upwards. Unless otherwise specified, use of the term “subterranean formation” shall be construed as encompassing both areas below exposed earth and areas below earth covered by water such as ocean or fresh water.

Various values and/or ranges may be explicitly disclosed in certain embodiments herein. However, values/ranges from any lower limit may be combined with any upper limit to recite a range not explicitly recited. Similarly, values/ranges from any lower limit may be combined with any other lower limit to recite a range not explicitly recited. In the same way, values/ranges from any upper limit may be combined with any other upper limit to recite a range not explicitly recited. Additionally, whenever a numerical range with a lower limit and an upper limit is disclosed, any number and any included range falling within the range are specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values even if not explicitly recited. Thus, every point or individual value may serve as its own lower or upper limit combined with any other point or individual value or any other lower or upper limit, to recite a range not explicitly recited. Similarly, an individual value disclosed herein may be combined with another individual value or range disclosed herein to form another range.

FIG. 1 illustrates a schematic side view of a well system 100 including a valve assembly 170 designed, manufactured and/or operated according to one or more embodiments of the disclosure. In one or more embodiments, the well system 100 includes a wellbore 105 extending from surface 110 of well 115 to a subterranean formation 120. Well 115 and a rig 125 thereof are illustrated onshore in FIG. 1. Alternatively, the operations described herein may be performed in an off-shore or over water environment. In the embodiment illustrated in FIG. 1, wellbore 105 has been formed by a drilling process in which dirt, rock and other subterranean materials have been removed to create wellbore 105. In some embodiments, a portion of wellbore 105 is cased with a casing. In other embodiments, at least a portion, if not an entirety, of the wellbore 105 is maintained in an open-hole configuration without casing. Thus, the embodiments described herein are applicable to either cased or open-hole configurations of the wellbore 105, or a combination of cased and open-hole configurations in a particular wellbore 105.

After the drilling of the wellbore 105 is complete and the associated drill bit and drill string are “tripped” from wellbore 105, a tubular 130 may be lowered into wellbore 105. In the embodiment of FIG. 1, the tubular 130 is lowered by a lift assembly 135 associated with a derrick 140 positioned on or adjacent to rig 125, as shown in FIG. 1. The lift assembly 135, in one or more embodiments, includes a hook 141, a cable 142, a traveling block (not shown), and a hoist (not shown) that cooperatively work together to lift or lower a swivel 143 that is coupled to an upper end of tubular 130. In some embodiments, the tubular 130 is raised or lowered as needed to add additional sections to tubular 130 and to run tubular 130 across a desired number of zones of the wellbore 105. In one or more embodiments, an inlet conduit 151 is coupled to a fluid source 150 and a pump 152 to provide fluids to an interior passageway 132 of the tubular 130, the interior passageway 132 providing a passageway for fluids and solid particles to flow downhole.

In one or more embodiments, the valve assembly 170 includes a ball valve 175, a remote-activated downhole system 180, an indexing mechanism 185 (e.g., pressure-activated indexing mechanism in one embodiment), and a latch mechanism 190. In at least one embodiment, while the ball valve 175 of the valve assembly 170 is in an open position, fluids flowing through interior passageway 132 also flow through and out of the valve assembly 170. In some embodiments, while ball valve 175 is in the open position, the interior passageway 132 also provides a fluid passageway for a fluid to flow uphole, where the fluid eventually flows into an outlet conduit 155, and from outlet conduit 155 into a reservoir 160. In some embodiments, tubular 130 also provides a fluid flow path for fluids to flow into one or more cross-over ports (not shown) that provide fluid flow around (such as up and/or below) the valve assembly 170. In some embodiments, one or more pumps (not shown) are employed to facilitate fluid flow downhole or uphole, and to generate pressure downhole or uphole.

In the embodiment of FIG. 1, the pump 152, in addition to facilitating fluid flow downhole, also generates various acoustic or time dependent pressure profiles. In at least one embodiment, the valve assembly 170 employs the remote-activated downhole system 180 to detect pressure signals, such as pressure signals generated by pump 152, determine whether any pressure signal has a signature profile that matches the signature profile of an activation pressure signal, and in response to a determination that the signature profile of the pressure signal matches the signature profile of the activation pressure signal, arm the indexing mechanism 185. Once the indexing mechanism 185 is armed, a threshold number of cycles of the threshold pressure may be applied to the indexing mechanism 185 to disengage latch mechanism 190, which in turn shifts the ball valve 175 between an open position and a closed position. In some embodiments, after the indexing mechanism 185 is armed, a single cycle of threshold pressure may be applied to the indexing mechanism 185 to disengage latch mechanism 190 from the indexing mechanism 185. In some other embodiments, multiple cycles of threshold pressure may be applied to the indexing mechanism 185 to disengage the latch mechanism 190 from the indexing mechanism 185. Additional descriptions of the remote-activated downhole system 180, the indexing mechanism 185, and the latch mechanism 190, and their corresponding components, are provided herein and are illustrated in at least FIGS. 3A through 3D.

The valve assembly 170, in one or more embodiment, includes a spring assembly designed, manufactured and/or operated according to one or more embodiments of the disclosure. The spring assembly, in one or more embodiments, is configure to assist in shifting the ball valve 175 between its closed position and its open position (e.g., shift the ball valve from the closed position to the open position in one embodiment) when the latch mechanism 190 disengages from the indexing mechanism 185. The spring assembly, in one or more embodiments, includes two or more independent wave springs that cooperate to form the spring assembly. The phrase “separate independent wave springs,” as used herein, means that the two or more wave springs do not form one continuous piece of material, and if necessary, may be separated from one another without destroying the spring assembly.

In at least one embodiment, each of the two or more separate independent wave springs extend less than 720 degrees around their axis of rotation (e.g., are less than a 2 turn wave spring). In yet another embodiment, each of the two or more separate independent wave springs extend less than 540 degrees around their axis of rotation (e.g., are less than a 1.5 turn wave spring). In even yet another embodiment, each of the two or more separate independent wave springs extend 360 degrees or less around their axis of rotation (e.g., are a 1 turn or less wave spring). In even a further embodiment, each of the two or more separate independent wave springs extend less than 360 degrees around their axis of rotation (e.g., are less than a 1 turn wave spring), if not from 270 degrees to 359 degrees around their axis of rotation. In even yet another further embodiment, each of the two or more separate independent wave springs extend from 336 degrees to 354 degrees around their axis of rotation.

In at least one embodiment, the two or more separate independent wave springs are rotationally coupled to one another such that peaks of adjacent ones of the two or more separate independent wave springs point toward one another, and valleys of the two or more separate independent wave springs point away from one another. In such an embodiment, when the spring assembly is in an uncompressed state, there will be a greater distance between the adjacent valleys than when the spring assembly is in a compressed state.

In at least one embodiment, the two or more separate independent wave springs are rotationally coupled to one another using one or more anti-rotation features. The anti-rotation features may comprise many different designs and remain within the scope of the disclosure. In at least one embodiment, however, each of the two or more separate independent wave springs have alignment key slots, the key slots configured to engage with a feature of a valve assembly (e.g., valve assembly 170 of FIG. 1) to rotationally couple the two or more separate independent wave springs together. In yet another embodiment, the anti-rotation feature is a clip or strap that couples between the adjacent peaks of the adjacent ones of the two or more separate independent wave springs. Given the arced nature of the wave springs, such a clip or strap could prevent the two or more separate independent wave springs from rotating relative to one another. In yet another embodiment, the anti-rotation features are one or more rods, one or more molded housing (e.g., plastic molded housings) that the two or more separate independent wave springs are installed over or inside, individual spot welds, etc.

Although FIG. 1 illustrates a single valve assembly 170, in some embodiments, multiple valve assemblies are deployed (not shown) in different sections of wellbore 105. Further, although FIG. 1 illustrates a ball valve 175, in some embodiments, the valve assembly 170 has a different valve, sleeves (not shown), or multiple valves (not shown). Further, although FIG. 1 illustrates a pump 152 (e.g., surface-based pump), in some embodiments, pump 152 is deployed downhole. In some embodiments, multiple pumps (not shown) are deployed to facilitate fluid flow, fluid circulation, and to generate an activation pressure signal. Further, although FIG. 1 illustrates a completion environment, it is understood that the valve assembly 170 and other valve assemblies described herein are deployable in other well environments and well operations, including, but not limited to drilling operations, intervention operations, measurement while drilling (MWD)/logging while drilling (LWD) operations, as well as other types of well environments and operations.

Turning to FIG. 2A, illustrated is a spring assembly 200A designed, manufactured and/or operated according to one or more embodiments of the disclosure. The spring assembly 200A, in one or more embodiments, includes two separate independent wave springs 210 (e.g., first separate independent wave spring 210a and second separate independent wave spring 210b) that cooperate to form the spring assembly 200A. In the embodiment of FIG. 2A, the two separate independent wave springs 210a, 210b are positioned proximate one another such that peaks of adjacent ones of the two separate independent wave springs 210a, 210b point toward one another, and valleys of the two separate independent wave springs 210a, 210b point away from one another. The term “proximate,” as used with respect to the placement of the two separate independent wave springs 210a, 210b relative to one another, means that a distance between the two separate independent wave springs 210a, 210b is within a largest diameter of each of the two separate independent wave springs 210a, 210b.

The spring assembly 200A of the embodiment of FIG. 2A additionally includes third and fourth separate independent wave springs 210c, 210d, respectively. In the illustrated embodiment, the first separate independent wave spring 210a has a first wave spring side and a first opposing wave spring side, and the second separate independent wave spring 210b has a second wave spring side and a second opposing wave spring side. In the illustrated embodiment of FIG. 2A, the first wave spring side and the second wave spring side face one another. Further to this embodiment, the third separate independent wave spring 210c is positioned proximate the first separate independent wave spring 210a, the third separate independent wave spring 210c having a third wave spring side and a third opposing wave spring side, the first opposing wave spring side facing the third opposing wave spring. Further to this embodiment, the fourth separate independent wave spring 210d is positioned proximate the second separate independent wave spring 210b, the fourth separate independent wave spring 210d having a fourth wave spring side and a fourth opposing wave spring side, the second opposing wave spring side facing the fourth opposing wave spring side. In the illustrated embodiment, peaks of third separate independent wave spring 210c point toward peaks of the first separate independent wave spring 210a, and peaks of fourth separate independent wave spring 210d point toward peaks of the second separate independent wave spring 210b. Notwithstanding, other embodiments (e.g., FIGS. 2C through 2F) exist wherein peaks of third separate independent wave spring 210c point toward valleys of the first separate independent wave spring 210a, and peaks of fourth separate independent wave spring 210d point toward valleys of the second separate independent wave spring 210b.

Notwithstanding, in the embodiment of FIG. 2A, the spring assembly 200A further includes fifth and sixth separate independent wave springs 210e, 210f. Nevertheless, unless otherwise stated, the present disclosure is not limited to any specific number of separate independent wave springs 210, so long as there are at least two and less than infinity (e.g., more than likely less than 500 separate independent wave springs 210). In fact, one of the benefits of the aspects of the present disclosure is that the spring assembly 200A is modular in nature, and thus a longer spring assembly 200A may be achieved by adding additional separate independent wave springs 210, and a shorter spring assembly 200A may be achieved by removing one or more of the separate independent wave springs 210.

The two or more separate independent wave springs 210 may comprise a variety of different materials and remain within the scope of the disclosure. For example, in at least one embodiment, the two or more separate independent wave springs 210 comprise a metal or metal alloy. In at least one embodiment, the two or more separate independent wave springs 210 comprise carbon steel or stainless steel (e.g., 17-7 stainless steel). In yet other embodiments, the two or more separate independent wave springs 210 comprise more exotic alloys, such as Inconel X-750® and Elgiloy®, for example to withstand practically any environment. In yet other embodiments, the two or more separate independent wave springs 210 comprise a non-metal material (e.g., high carbon spring materials).

As discussed above, in at least one embodiment, each of the two or more separate independent wave springs 210 extend less than 720 degrees around their axis of rotation (e.g., are less than a 2 turn wave spring). In yet another embodiment, each of the two or more separate independent wave springs 210 extend less than 540 degrees around their axis of rotation (e.g., are less than a 1.5 turn wave spring). In even yet another embodiment, each of the two or more separate independent wave springs 210 extend 360 degrees or less around their axis of rotation (e.g., are a 1 turn or less wave spring). In even a further embodiment, each of the two or more separate independent wave springs 210 extend less than 360 degrees around their axis of rotation (e.g., are less than a 1 turn wave spring), if not from 270 degrees to 359 degrees around their axis of rotation. In even yet another further embodiment, each of the two or more separate independent wave springs 210 extend from 336 degrees to 354 degrees around their axis of rotation.

In the illustrated embodiment, the two or more separate independent wave springs 210 are rotationally coupled to one another such that peaks 220 of adjacent ones of the two or more separate independent wave springs 210 point toward one another, and valleys 225 of the two or more separate independent wave springs 210 point away from one another. In such an embodiment, when the spring assembly 200A is in an uncompressed state (e.g., less compressed state) there will be a greater distance (do) between the adjacent valleys 225 than when the spring assembly 200A is in a compressed state (e.g., more compressed state).

In at least one embodiment, the two or more separate independent wave springs 210 are rotationally coupled to one another using one or more anti-rotation features 230. The anti-rotation features 230 may comprise many different designs and remain within the scope of the disclosure. In at least one embodiment, each of the two or more separate independent wave springs 210 have alignment key slots 235, the key slots 235 configured to engage with a feature (e.g., key) of a valve assembly (e.g., valve assembly 170 of FIG. 1) to rotationally couple the two or more separate independent wave springs 210 together. In such an embodiment, the two or more separate independent wave springs 210 having the alignment key slots 235 (e.g., axially aligned key slots) could axially slide upon the key when moving between the uncompressed stated (e.g., less compressed state) and the compressed stated (e.g., more compressed state) while being rotationally coupled to one another.

In at least one embodiment, at least two of the two or more separate independent wave springs 210 are similarly shaped wave springs (e.g., circumference, diameter, shape of the waves, etc., but for the inclusion of the anti-rotation feature 230). The term “similarly shaped,” as used herein, means they are shaped within 10 percent of identical (e.g., circumference, diameter, shape of the waves, etc., but for the inclusion of the anti-rotation feature 230). In at least one other embodiment, at least two of the two or more separate independent wave springs 210 are substantially similarly shaped wave springs (e.g., circumference, diameter, shape of the waves, etc., but for the inclusion of the anti-rotation feature 230). The term “substantially similarly shaped,” as used herein, means they are shaped within 5 percent of identical (e.g., circumference, diameter, shape of the waves, etc., but for the inclusion of the anti-rotation feature 230). In at least one other embodiment, at least two of the two or more separate independent wave springs 210 are exactly shaped wave springs (e.g., circumference, diameter, shape of the waves, etc., but for the inclusion of the anti-rotation feature 230). The term “exactly shaped,” as used herein, means they are shaped within 2 percent of identical (e.g., circumference, diameter, shape of the waves, etc., but for the inclusion of the anti-rotation feature 230). In even another embodiment, at least two of the two or more separate independent wave springs 210 are identically shaped wave springs (e.g., circumference, diameter, shape of the waves, etc., but for the inclusion of the anti-rotation feature 230).

Turning to FIG. 2B, illustrated is a spring assembly 200B designed, manufactured and/or operated according to one or more alternative embodiments of the disclosure. The spring assembly 200B of FIG. 2B is similar in many respects to the spring assembly 200A of FIG. 2A. Accordingly, like reference numbers have been used to indicate similar, if not identical, features. The spring assembly 200B differs, for the most part, from the spring assembly 200A in that the spring assembly 200B does not employ the alignment key slots 235 as its anti-rotation feature 230, but employs one or more clips or straps 255 as its anti-rotation feature 230. In the illustrated embodiment, the spring assembly 200B includes five clips or straps 255a, 255b, 255c, 255d, 255e rotationally fixing the six separate independent wave springs 210a, 210b, 210c, 210d, 210e, 210f. The one or more clips or straps 255 may comprise many different materials and may take on many different sizes and shapes and remain within the scope of the disclosure.

The embodiment of FIGS. 2A and 2B have arranged the six separate independent wave springs 210a, 210b, 210c, 210d, 210e, 210f in a configuration much like ΛΛΛ, as taken through the dotted line 240. In yet another embodiment, the six separate independent wave springs 210a, 210b, 210c, 210d, 210e, 210f, could be arranged like AVA, and remain within the scope of the disclosure. In yet another embodiment, for example if eight separate independent wave springs 210 were used, they could be arranged like /ΛVΛ\ (spring assembly 200C, 200D of FIGS. 2C & 2D, for example additionally including seventh, eighth, ninth, tenth, eleventh and twelfth separate independent wave springs 210g, 210h, 210i, 210j, 210k, 2101, respectively), and if twelve separate independent wave springs were used, they could be arranged like //Λ\\V/Λ\\(spring assembly 200E, 200F of FIGS. 2E & 2F, for example additionally including seventh, eighth, ninth, tenth, eleventh, twelfth, thirteenth, fourteenth, fifteenth, sixteenth, seventeenth, and eighteenth separate independent wave springs 210g, 210h, 210i, 210j, 210k, 2101, 210m, 210n, 2100, 210p, 210q, 210r, respectively), or any combination of the foregoing, depending on the number of separate independent wave springs that are required. It should be noted that the present disclosure is not limited to a specific number of stacked sets of separate independent wave springs, and moreover that any configuration of aligned peaks or valleys, for example along with the above requirement of two separate independent wave springs positioned proximate one another such that peaks of adjacent ones of the two separate independent wave springs point toward one another, and valleys of the two separate independent wave springs point away from one another, is within the scope of the present disclosure. Stated another way, other embodiments may exist wherein a peak(s) and a valley(s) of additional separate independent wave springs (e.g., third, fourth, fifth, sixth, etc.) on either side of the required two separate independent wave springs may point toward, away, or any combination thereof from other proximate peak(s) and valley(s). Thus, unless otherwise stated, the present disclosure accommodates any configuration that includes at least the two separate independent wave springs positioned proximate one another such that the peaks of adjacent ones of the two separate independent wave springs point toward one another, and the valleys of the two separate independent wave springs point away from one another, along with any other number and rotational configuration of separate independent wave springs.

Turning to FIGS. 3A through 3D, illustrated are schematic, cross-sectional views of a valve assembly 300 (e.g., pressure activated valve assembly) designed, manufactured and/or operated according to one or mor embodiments of the disclosure. In at least one embodiment, the valve assembly 300 is similar to the valve assembly 170 of FIG. 1, and thus is deployable within a wellbore. In the embodiment of FIGS. 3A through 3D, the valve assembly 300 includes a remote-activated downhole system 340, an indexing mechanism 350 (e.g., pressure-activated indexing mechanism), and a latch mechanism 380.

In at least one embodiment, the valve assembly 300 has a bore 310, and a piston 312 that is positioned in the sidewall of the valve assembly 300. Pressure flowing through bore 310 also flows through opening 314 to apply pressure to piston 312. In some embodiments, the valve assembly 300 also includes a filter that is positioned along a sidewall thereof. In one or more of such embodiments, pressure flowing through bore 310 also flow through opening 314 and the filter to apply pressure to piston 312. In the illustrated embodiment, the piston 312 is positioned adjacent to a low-pressure chamber 316 that is partially or completely filled with a compressible fluid 318 such as silicon oil.

In the embodiment of FIGS. 3A through 3D, the low-pressure chamber 316 also extends to a region 320 that is between seals 322 and 324. In one or more of such embodiments, a port (not shown) fluidly connects region 320 of low-pressure chamber 316 with the other regions of low-pressure chamber 316. Further, in the embodiment of FIGS. 3A through 3D, the compressible fluid 318 also partially or completely fills high-pressure chamber 326 of the valve assembly 300 and along annular regions in the sidewall of the valve assembly 300. Pressure (such as fluid pressure) applied by piston 312, as piston 312 shifts from a first position to a second position, flows into region 320.

Pressure applied by piston 312, in one or more embodiments, also flows through a check valve 328 into the high-pressure chamber 326. In the embodiment of FIGS. 3A through 3D, the check valve 328 is a valve that permits fluid and pressure to flow into high-pressure chamber 326, but restricts fluid and pressure to flow out of high-pressure chamber 326, such that fluid or pressure flow out check valve 328 at a rate that is less than a threshold rate (e.g., to induce a pressure differential). In some embodiments, the check valve 328 includes or is coupled to a restrictor (not shown) that prevents or reduces fluid and pressure flow out of high-pressure chamber 326. In that regard, when pressure in low-pressure chamber 316 is reduced, such as by shifting piston 312 back to the first position, pressure in low-pressure chamber 316 (which includes region 320) is reduced. However, pressure across high-pressure chamber 326 is prevented by check valve 328 from being reduced or from being reduced at the same rate as the rate pressure in low-pressure chamber 316 is reduced, thereby creating a pressure differential across an indexing piston 355 of the indexing mechanism 350 that is positioned adjacent to region 320 of low-pressure chamber 316 and high-pressure chamber 326.

The pressure-differential across region 320 of low-pressure chamber 316 and high-pressure chamber 326 in turn applies a pressure or differential pressure to the indexing piston 355. In the embodiment of FIGS. 3A through 3D, the indexing piston 355 is shifted from the first position illustrated in FIGS. 3A through 3D to a second position (not show) to the left of the position illustrated in FIGS. 3A through 3D in response to a threshold amount of pressure or differential pressure being applied by the pressure or pressure differential across region 320 of low-pressure chamber 316 and high-pressure chamber 326. In one or more of such embodiments, the indexing piston 355 shifts from the first position to the second position after the threshold pressure or differential pressure is applied for a threshold period of time (e.g., one second, five seconds, ten seconds, or a different period of time). The indexing piston 355 also applies a force to a spring 330 that is positioned in the high-pressure chamber 326, thereby compressing the spring 330.

In at least on embodiment, over time (e.g., one hour, five hours, ten hours, or another period of time), pressure in high-pressure chamber 326 slowly flows or bleeds out of high-pressure chamber 326 through a restrictor (not shown), and into low-pressure chamber 316, thereby reducing the pressure or pressure differential across region 320 of low-pressure chamber 316 and high-pressure chamber 326. As the pressure or pressure differential across region 320 of low-pressure chamber 316 and high-pressure chamber 326 reduces below a threshold, the potential energy stored in the compressed state of spring 330 is released, which in turn shifts the indexing piston 355 from the second position back to the first position. In some embodiments, applying additional pressure to region 320 of low-pressure chamber 316 reduces the pressure differential across region 320 of low-pressure chamber 316 and high-pressure chamber 326 below the threshold. In such embodiments, the potential energy stored in the compressed state of spring 330 is released, which in turn shifts the indexing piston 355 from the second position back to the first position.

The indexing piston 355, in one or more embodiments, is coupled to an indexing mandrel 385 such that each time the indexing piston 355 shifts from the first position to the second position, the indexing piston 355 pulls indexing mandrel 385 through one or more lock rings 332 to shift the indexing mandrel 385 by an increment (e.g., to the left in this embodiment). Moreover, lock rings 332 are configured such that when the indexing piston 355 shifts from the second position back to the first position, the one or more of lock rings 332 prevent indexing mandrel 385 from being shifted by one increment in the opposite direction (e.g., to the right) and to its previous position. Moreover, the indexing mandrel 385 moves an additional increment (e.g., to the left) after each pressure cycle described herein, where a threshold pressure or pressure differential is applied to the indexing piston 355 for a threshold period of time per cycle. In the embodiment of FIGS. 3A through 3D, the indexing mandrel 385 is coupled to a latch 390. Further, applying a threshold number of pressure cycles (e.g., one cycle, two cycles, five cycles, or a different number of cycles of threshold pressure or pressure differential) to the indexing piston 355 shifts the indexing mandrel 385 by the threshold number of increments to disengage latch 390.

In one or more embodiments, the latch 390 is coupled to a spring assembly 360 (e.g., in a compressed state) while latch 390 is engaged to indexing mandrel 385. The spring assembly 360 may be any spring assembly designed and/or manufactured according to the disclosure, including the spring assembly 200A-200F of FIGS. 2A through 2F. After the latch 390 disengages from indexing mandrel 385, the spring assembly 360 is permitted to return to a less compressed state (e.g., natural state). Further the force released by the spring assembly 360 in turn shifts the mandrel 362 (or a profiled portion 364 of the mandrel 362) from a first position illustrated in FIGS. 3A through 3D to a second position (not shown) to the left of the first position of the mandrel 362. The mandrel 362 in turn shifts a ball 366 of the valve assembly 300 from a closed position illustrated in FIGS. 3A through 3D to an open position (not shown) as the mandrel 362 shifts from the first position to the second position, thereby opening the valve assembly 300. In some embodiments, the spring assembly 360 is coupled to the mandrel 362 such that the mandrel 362 (or profiled portion 364 of the mandrel) is shifted from the first position to the second position as the spring assembly 360 returns to its natural state.

In the embodiment of FIGS. 3A through 3D, the indexing mechanism 350 (e.g., low-pressure chamber pressure-activated indexing mechanism) includes the low-pressure chamber 316, the check valve 328, the high-pressure chamber 326, the lock rings 332, the indexing piston 355, and the indexing mandrel 385. In some embodiments, the indexing mechanism 350 includes different components of the valve assembly 300. Further, in the embodiment of FIGS. 3A through 3D, the latch mechanism 380 includes the latch 390, the spring assembly 360, and the mandrel 362. In some embodiments, the latch mechanism 380 includes different components of the valve assembly 300. Further, although the above paragraphs describe performing operations by components of the valve assembly 300 to shift the ball 366 to an open position, it is understood that where the ball 366 is initially in an open position, similar or identical operations as the operations described herein may also be performed to shift the ball 366 from the open position to the closed position.

### Aspects Disclosed Herein Include:

A. A spring assembly, the wave spring including: 1) two separate independent wave springs positioned proximate one another such that peaks of adjacent ones of the two separate independent wave springs point toward one another, and valleys of the two separate independent wave springs point away from one another; and 2) one or more anti-rotation features rotationally coupling the two separate independent wave springs together.

B. A valve assembly, the valve assembly including: 1) a valve; 2) a latch mechanism configured to shift the valve between an open position and a close position; 3) a spring assembly coupled with the latch mechanism, the spring assembly including: a) two separate independent wave springs positioned proximate one another such that peaks of adjacent ones of the two separate independent wave springs point toward one another, and valleys of the two separate independent wave springs point away from one another; and b) one or more anti-rotation features rotationally coupling the two separate independent wave springs together; 4) an indexing mechanism engaged with the latch mechanism and in an unarmed mode, the indexing mechanism configured to disengage from the latch mechanism to shift the valve between the open position and the closed position when receiving at least one cycle of threshold pressure; and 5) a remote-activated downhole system coupled with the indexing mechanism, the remote-activated downhole system configured to: a) receive an activation pressure signal; and b) in response to receiving the activation pressure signal, arm the indexing mechanism.

C. A well system, the well system including: 1) wellbore extending through one or more subterranean formations; 2) a valve assembly located in the wellbore, the valve assembly including: a) a valve; b) a latch mechanism configured to shift the valve between an open position and a close position; c) a spring assembly coupled with the latch mechanism, the spring assembly including: i) two separate independent wave springs positioned proximate one another such that peaks of adjacent ones of the two separate independent wave springs point toward one another, and valleys of the two separate independent wave springs point away from one another; and ii) one or more anti-rotation features rotationally coupling the two separate independent wave springs together; 3) an indexing mechanism engaged with the latch mechanism and in an unarmed mode, the indexing mechanism configured to disengage from the latch mechanism to shift the valve between the open position and the closed position when receiving at least one cycle of threshold pressure; and 4) a remote-activated downhole system coupled with the indexing mechanism, the remote-activated downhole system configured to: a) receive an activation pressure signal; and b) in response to receiving the activation pressure signal, arm the indexing mechanism.

Aspects A, B, and C may have one or more of the following additional elements in combination: Element 1: wherein a first of the two separate independent wave springs has a first wave spring side and a first opposing wave spring side, and a second of the two separate independent wave springs has a second wave spring side and a second opposing wave spring side, and further wherein the first wave spring side and the second wave spring side face one another, the spring assembly further including: a third separate independent wave spring positioned proximate the first separate independent wave spring, the third separate independent wave spring having a third wave spring side and a third opposing wave spring side, the first opposing wave spring side facing the third opposing wave spring side; and a fourth separate independent wave spring positioned proximate the second separate independent wave spring, the fourth separate independent wave spring having a fourth wave spring side and a fourth opposing wave spring side, the second opposing wave spring side facing the fourth opposing wave spring side, the one or more anti-rotation features rotationally coupling the two separate independent wave springs, the third separate independent wave spring, and the fourth separate independent wave spring together. Element 2: wherein peaks of third separate independent wave spring point toward peaks of the first of the two separate independent wave springs, and peaks of fourth separate independent wave spring point toward peaks of the second of the two separate independent wave springs. Element 3: wherein peaks of third separate independent wave spring point toward valleys of the first of the two separate independent wave springs, and peaks of fourth separate independent wave spring point toward valleys of the second of the two separate independent wave springs. Element 4: wherein the two separate independent wave springs each extend 360 degrees or less around their axis of rotation. Element 5: wherein the two separate independent wave springs each extend from 270 degrees to 359 degrees around their axis of rotation. Element 6: wherein the one or more anti-rotation features are alignment key slots located in each of the two separate independent wave springs. Element 7: wherein the alignment key slots are rotationally aligned when the two separate independent wave springs are rotationally coupled together. Element 8: wherein the one or more anti-rotation features are one or more clips or straps rotationally coupling the two separate independent wave springs together. Element 9: wherein the one or more clips or straps couple between the adjacent peaks of the adjacent ones of the two separate independent wave springs.

Those skilled in the art to which this application relates will appreciate that other and further additions, deletions, substitutions and modifications may be made to the described embodiments.

What is claimed is:

1. A spring assembly, comprising:
two separate independent wave springs positioned proximate one another such that peaks of adjacent ones of the two separate independent wave springs point toward one another, and valleys of the two separate independent wave springs point away from one another; and
one or more anti-rotation features rotationally coupling the two separate independent wave springs together.

2. The spring assembly as recited in claim 1, wherein a first of the two separate independent wave springs has a first wave spring side and a first opposing wave spring side, and a second of the two separate independent wave springs has a second wave spring side and a second opposing wave spring side, and further wherein the first wave spring side and the second wave spring side face one another, the spring assembly further including:
a third separate independent wave spring positioned proximate the first separate independent wave spring, the third separate independent wave spring having a third wave spring side and a third opposing wave spring side, the first opposing wave spring side facing the third opposing wave spring side; and
a fourth separate independent wave spring positioned proximate the second separate independent wave spring, the fourth separate independent wave spring having a fourth wave spring side and a fourth opposing wave spring side, the second opposing wave spring side facing the fourth opposing wave spring side, the one or more anti-rotation features rotationally coupling the two separate independent wave springs, the third separate independent wave spring, and the fourth separate independent wave spring together.

3. The spring assembly as recited in claim 2, wherein peaks of third separate independent wave spring point toward peaks of the first of the two separate independent wave springs, and peaks of fourth separate independent wave spring point toward peaks of the second of the two separate independent wave springs.

4. The spring assembly as recited in claim 2, wherein peaks of third separate independent wave spring point toward valleys of the first of the two separate independent wave springs, and peaks of fourth separate independent wave spring point toward valleys of the second of the two separate independent wave springs.

5. The spring assembly as recited in claim 1, wherein the two separate independent wave springs each extend 360 degrees or less around their axis of rotation.

6. The spring assembly as recited in claim 1, wherein the two separate independent wave springs each extend from 270 degrees to 359 degrees around their axis of rotation.

7. The spring assembly as recited in claim 1, wherein the one or more anti-rotation features are alignment key slots located in each of the two separate independent wave springs.

8. The spring assembly as recited in claim 7, wherein the alignment key slots are rotationally aligned when the two separate independent wave springs are rotationally coupled together.

9. The spring assembly as recited in claim 1, wherein the one or more anti-rotation features are one or more clips or straps rotationally coupling the two separate independent wave springs together.

10. The spring assembly as recited in claim 9, wherein the one or more clips or straps couple between the adjacent peaks of the adjacent ones of the two separate independent wave springs.

11. A valve assembly, comprising:
a valve;
a latch mechanism configured to shift the valve between an open position and a close position;
a spring assembly coupled with the latch mechanism, the spring assembly including:
two separate independent wave springs positioned proximate one another such that peaks of adjacent ones of the two separate independent wave springs point toward one another, and valleys of the two separate independent wave springs point away from one another; and
one or more anti-rotation features rotationally coupling the two separate independent wave springs together;
an indexing mechanism engaged with the latch mechanism and in an unarmed mode, the indexing mechanism configured to disengage from the latch mechanism to shift the valve between the open position and the closed position when receiving at least one cycle of threshold pressure; and
a remote-activated downhole system coupled with the indexing mechanism, the remote-activated downhole system configured to:
receive an activation pressure signal; and
in response to receiving the activation pressure signal, arm the indexing mechanism.

12. The valve assembly as recited in claim 11, wherein a first of the two separate independent wave springs has a first wave spring side and a first opposing wave spring side, and a second of the two separate independent wave springs has a second wave spring side and a second opposing wave spring side, and further wherein the first wave spring side and the second wave spring side face one another, the spring assembly further including:
a third separate independent wave spring having a third wave spring side and a third opposing wave spring side positioned proximate the first separate independent wave spring, the first opposing wave spring side facing the third opposing wave spring side; and
a fourth separate independent wave spring having a fourth wave spring side and a fourth opposing wave spring side positioned proximate the second separate independent wave spring, the second opposing wave spring side facing the fourth opposing wave spring side, the one or more anti-rotation features rotationally coupling the two separate independent wave springs, the third separate independent wave spring, and the fourth separate independent wave spring together.

13. The valve assembly as recited in claim 12, wherein peaks of third separate independent wave spring point toward peaks of the first of the two separate independent wave springs, and peaks of fourth separate independent wave spring point toward peaks of the second of the two separate independent wave springs.

14. The valve assembly as recited in claim 12, wherein peaks of third separate independent wave spring point toward valleys of the first of the two separate independent wave springs, and peaks of fourth separate independent wave spring point toward valleys of the second of the two separate independent wave springs.

15. The valve assembly as recited in claim 11, wherein the two separate independent wave springs each extend 360 degrees or less around their axis of rotation.

16. The valve assembly as recited in claim 11, wherein the two separate independent wave springs each extend from 270 degrees to 359 degrees around their axis of rotation.

17. The valve assembly as recited in claim 11, wherein the one or more anti-rotation features are alignment key slots located in each of the two separate independent wave springs.

18. The valve assembly as recited in claim 17, wherein the alignment key slots are rotationally aligned when the two separate independent wave springs are rotationally coupled together.

19. The valve assembly as recited in claim 11, wherein the one or more anti-rotation features are one or more clips or straps rotationally coupling the two separate independent wave springs together.

20. The valve assembly as recited in claim 19, wherein the one or more clips or straps couple between the adjacent peaks of the adjacent ones of the two separate independent wave springs.

21. A well system, comprising:
a wellbore extending through one or more subterranean formations;
a valve assembly located in the wellbore, the valve assembly including;
a valve;
a latch mechanism configured to shift the valve between an open position and a close position;
a spring assembly coupled with the latch mechanism, the spring assembly including:
two separate independent wave springs positioned proximate one another such that peaks of adjacent ones of the two separate independent wave springs point toward one another, and valleys of the two separate independent wave springs point away from one another; and
one or more anti-rotation features rotationally coupling the two separate independent wave springs together;
an indexing mechanism engaged with the latch mechanism and in an unarmed mode, the indexing mechanism configured to disengage from the latch mechanism to shift the valve between the open position and the closed position when receiving at least one cycle of threshold pressure; and
a remote-activated downhole system coupled with the indexing mechanism, the remote-activated downhole system configured to:
receive an activation pressure signal; and
in response to receiving the activation pressure signal, arm the indexing mechanism.
